(19) United States
(12) Patent Application Publication
(10) Pub. No.: US 2017/0053394 A1
(43) Pub. Date: Feb. 23, 2017

(54) INSPECTION APPARATUS, INSPECTION METHOD, AND ARTICLE MANUFACTURING METHOD

(71) Applicant: CANON KABUSHIKI KAISHA, Tokyo (JP)

(72) Inventor: Takanori Uemura, Saitama-shi (JP)

(21) Appl. No.: 15/229,638

(22) Filed: Aug. 5, 2016

(30) Foreign Application Priority Data
Aug. 18, 2015 (JP) 2015-161270

(51) Int. Cl. G06T 7/00; G06K 9/20; G06T 15/50

(52) U.S. Cl. CPC G06T 7/0004; G06T 15/506; G06K 9/2027; G06K 9/2036

(57) ABSTRACT

An inspection apparatus which inspects a curved surface of an object is provided. An imaging device images the curved surface with a first region undergone bright field illumination by an illumination device in a first state, and images the curved surface with a second region undergone bright field illumination and with the first region undergone dark field illumination by the illumination device in a second state on a light-receiving condition that the imaging device receives a light amount required to obtain a dark field image of the first region undergone the dark field illumination. A processor performs a process for an inspection of the first region based on a bright field image of the first region undergone the bright field illumination and the dark field image of the first region undergone the dark field illumination.

### BACKGROUND OF THE INVENTION

Field of the Invention

The present invention relates to an inspection apparatus, an inspection method, and an article manufacturing method.

Description of the Related Art

An inspection apparatus which detects a defect and determines the quality of the outer appearance of an object by, replacing a visual inspection, processing an image of the object imaged by a camera has recently been introduced to an inspection of the outer appearance of the object. In an inspection of the outer appearance of an object having a plurality of surfaces, it is sometimes required that the inspection is performed not only on a surface (upper surface) relative to the direction of a camera but also on the side or side face or side surface of the object. Japanese Patent No. 4093460 discloses an inspection apparatus which, in order to inspect the side surface of an object, arranges a half mirror with a tilted state with respect to the side surface of the object, illuminates the side surface of the object by an illumination device arranged on the rear surface of the half mirror, and causes a single camera to capture a reflected image from the side surface of the object. Further, Japanese Patent Laid-Open No. 2012-173194 discloses an inspection apparatus which, in order to inspect the side surface of a cylindrical object, illuminates the side surface of the object with striped pattern light and captures an image while rotating the object.

The inspection apparatus described in Japanese Patent No. 4093460 is disadvantage in the inspection because it assumes that an object is made of a polyhedron such as an insert pin of a zipper, and appropriate illumination is not performed on an object having a curved surface as the side surface. On the other hand, the inspection apparatus described in Japanese Patent Laid-Open No. 2012-173194 is disadvantage in the inspection because it assumes that an object has a cylindrical shape such as a film roll, and the distance between a camera and the surface of the object changes by rotation for an object having a shape other than the cylindrical shape.

### SUMMARY OF THE INVENTION

The present invention provides, for example, an inspection apparatus advantageous in inspection of a curved surface of an object.

According to one aspect of the present invention, an inspection apparatus is provided. The apparatus comprises an illumination device, an imaging device, and a processor, and is configured to inspect a curved surface of an object including a first region and a second region, wherein the illumination device is configured to be in a first state in which illumination light is emitted from a first position in a first direction and a second state in which illumination light is emitted from a second position in a second direction, the imaging device is configured to image the curved surface with the first region undergone bright field illumination by the illumination device in the first state, and image the curved surface with the second region undergone bright field illumination and with the first region undergone dark field illumination by the illumination device in the second state on a light-receiving condition that the imaging device receives a light amount required to obtain a dark field image of the first region undergone the dark field illumination, and the processor is configured to perform a process for an inspection of the first region based on a bright field image of the first region undergone the bright field illumination and the dark field image of the first region undergone the dark field illumination.

Further features of the present invention will become apparent from the following description of exemplary embodiments (with reference to the attached drawings).

### BRIEF DESCRIPTION OF THE DRAWINGS

FIG. 1 is a diagram showing an inspection apparatus according to an embodiment;

FIG. 2 is a view showing an illumination device according to the first embodiment;

FIG. 3 shows views of images of the side surface of an object imaged at different positions of light sources and in different emission directions of illumination light;

FIG. 4 is a view showing an illumination device according to the second embodiment; and

FIG. 5 is a view showing an illumination device according to the third embodiment.

### DESCRIPTION OF THE EMBODIMENTS

Various exemplary embodiments, features, and aspects of the invention will be described in detail below with reference to the drawings. Note that the same reference numerals denote the same members and elements throughout the drawings, and the repetitive description will be omitted.

### First Embodiment

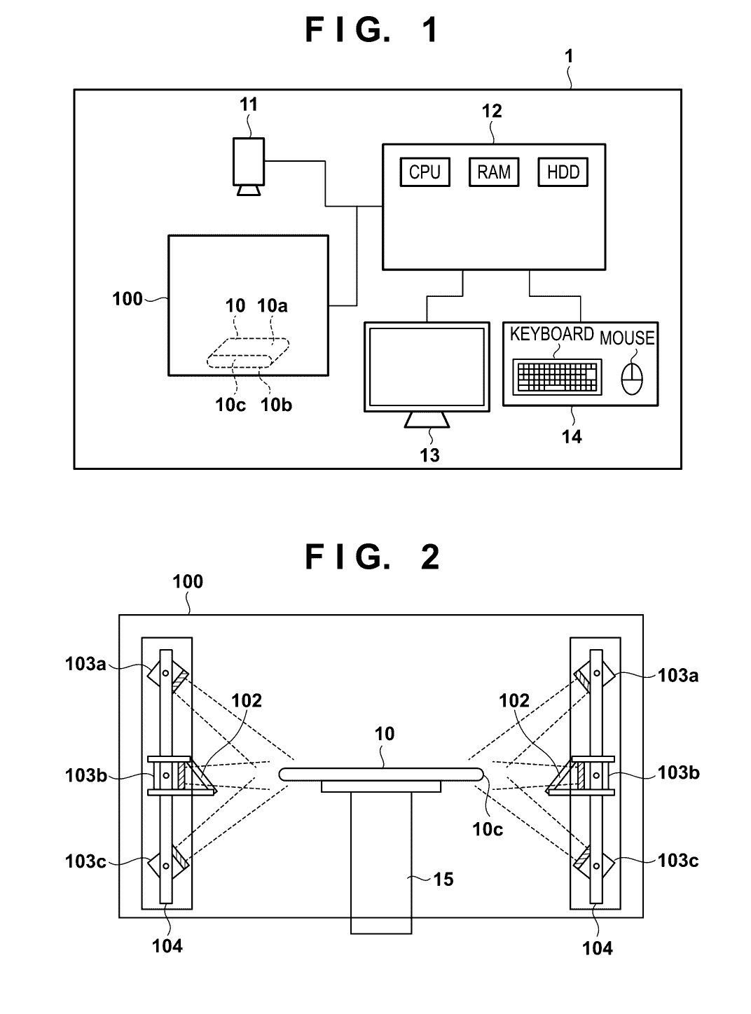

An inspection apparatus 1 according to an embodiment will be described with reference to FIG. 1. FIG. 1 shows an example of the inspection apparatus 1 according to this embodiment. The inspection apparatus 1 performs, for example, an inspection of the outer appearance of an object 10 (target object) such as a metal component or a resin component utilized for an industrial product. The inspection apparatus 1 inspects the surface of the object 10 having an upper surface 10a, a lower surface 10b, and a side surface 10c as a curved surface. When the object 10 is, for example, a portable information terminal or a smartphone, the inspection apparatus 1 inspects the upper surface 10a and the side surface 10c. The inspection apparatus 1 separately inspects the lower surface 10b where a glass plate of the portable information terminal or the smartphone exists. A defect, for example, a scratch, nonuniformity (such as color nonuniformity), unevenness such as a dent, or adhesion of a foreign substance or contaminant may be caused on the surface of the object 10. Based on an image of the side surface (curved surface) 10c of the object 10, the inspection apparatus 1 detects a defect caused in an inspection region on the side surface 10c and determines the quality of the object 10. The inspection region may be set on the entire side surface 10c or may be set in a portion from which a region in no need of the inspection is removed. The inspection region may further include the upper surface 10a.

The inspection apparatus 1 includes a camera (imaging device) 11, a processor 12, a display unit 13, an input unit 14, and an illumination device 100. The object 10 is conveyed into an illumination region of the illumination device 100 by a conveyance system (not shown) and illuminated. The illumination device 100 is arranged on the side of the upper surface 10a of the object 10. The imaging device 11 images the object 10 illuminated by the illumination device 100 to obtain an image. FIG. 1 only shows one imaging device 11. However, the inspection apparatus 1 may include the plurality of imaging devices 11 so that the entire inspection region can be imaged even though the object 10 is large. Details of the illumination device 100 will be described later.

The image of the object 10 obtained by the imaging device 11 is transferred or transmitted to the processor 12. The processor 12 can be, for example, an information processing apparatus which includes a CPU 12a, a RAM 12b, and an HDD (Hard Disk Drive) 12c. The processor 12 obtains an evaluation value for the image obtained by the illumination device 100, and decides the quality of the object 10 based on the obtained evaluation value and an allowance (threshold) of the evaluation value. The CPU 12a executes a program for determining the quality of the object 10. The RAM 12b and the HDD 12c store programs and data. The display unit 13 includes a monitor or the like and displays a result of the quality determination executed by the processor 12. The input unit 14 includes, for example, a keyboard and a mouse, and transmits an instruction from a user to the processor 12.

The illumination device 100 of the first embodiment will be described with reference to FIG. 2. The illumination device 100 includes a plurality of light sources 103a to 103c, stands 104 which hold them, and half mirrors (transmissive mirrors) 102 each serving as a mirror which reflects light from the side surface 10c toward the imaging device 11. Each half mirror 102 is arranged on a path of light from each light source 103b. Each light source 103a is arranged at the first position diagonally above the object 10 and forms the first light source which emits illumination light toward the object 10 diagonally below in the first direction. Each light source 103b is arranged at the second position which is almost flush with the position of the object 10 in the vertical direction and forms the second light source which emits illumination light in the horizontal second direction. The light emitted from each light source 103b is partially transmitted through the half mirror 102 and illuminates the side surface 10c of the object 10 in the horizontal direction. Each light source 103c is arranged diagonally below the object 10 and emits illumination light toward the object 10 diagonally above. Including each light source 103a and each light source 103b, the illumination device 100 can be set in the first state in which the illumination light is emitted from the first position in the first direction and the second state in which the illumination light is emitted from the second position in the second direction. In this embodiment, the stands 104 hold the half mirrors 102, in addition to the plurality of light sources 103a to 103c. A conveyance system 15 conveys the object 10 into the illumination region of the illumination device 100.

Some light beams emitted by the light sources 103a to 103c and reflected or scattered by the side surfaces 10c of the object 10 enter the half mirrors 102, and enter the imaging device 11 arranged above the object 10. Accordingly, the imaging device 11 obtains images of an inspection region on the side surfaces 10c of the object 10 via the half mirrors 102.

As shown in FIG. 2, a plurality of groups of the plurality of light sources 103a to 103c, the stands 104, and the half mirrors 102 can be arranged so as to surround the object 10 in the right-and-left and back-and-forth directions. This is for obtaining images simultaneously in the right-and-left and back-and-forth directions of the side surfaces 10c of the object 10. The imaging device 11 receives, at once, light reflected above by the plurality of half mirrors 102. This makes it possible to achieve the smaller number of imaging devices 11, a decrease in a load on image processing by the processor 12, and a reduction in a cost as compared with a case in which the imaging devices 11 are arranged in two directions in order to image the both side surfaces of the object 10.

The processor 12 controls the light sources 103a, 103b, and 103c to be sequentially turned on. The processor 12 controls the imaging device 11 in synchronism with turn-on of the light sources 103. Consequently, images of the inspection region on each side surface 10c of the object 10 are obtained on a plurality of conditions having different incident angles of illumination light.

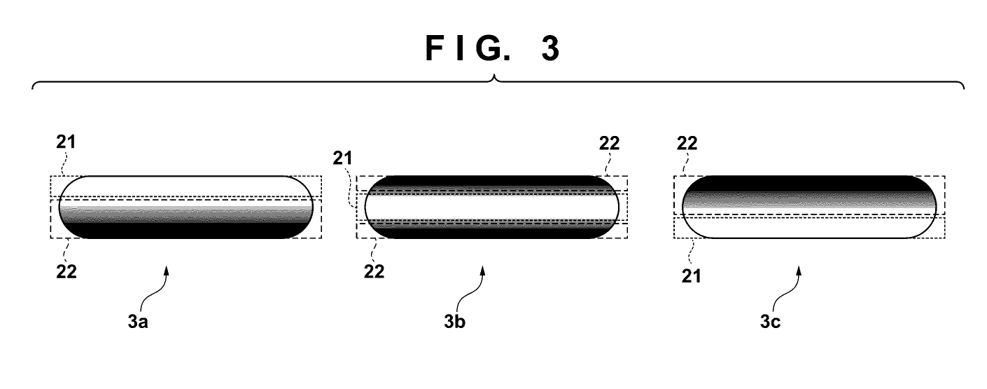

FIG. 3 shows images 3a to 3c of each side surface 10c of the object 10 imaged by switching between the plurality of light sources 103a to 103c. In FIG. 3, the image 3a is obtained by imaging the side surface 10c of the object 10 on a condition that the corresponding light source 103a is turned on. The light sources 103a illuminate the side surface 10c having a curvature from diagonally above. Therefore, in the image 3a, an upper region (first region) becomes a bright field image region 21 illuminated in bright field illumination, and a central region (second region) and a lower region become a dark field image region 22 illuminated in dark field illumination. The image 3b is obtained by imaging the side surface 10c of the object 10 on a condition that the corresponding light source 103b is turned on. The light source 103b illuminates the side surface 10c having the curvature in the horizontal direction. Therefore, a center region (second region) of the image 3b becomes the bright field image region 21, obtaining a bright image. On the other hand, an upper region (first region) and a lower region of the image 3b become the dark field image regions 22. The image 3c is obtained by imaging the side surface 10c of the object 10 on a condition that the corresponding light source 103c is turned on. The light source 103c illuminates the side surface 10c having the curvature from diagonally below. Therefore, a lower region of the image 3c becomes the bright field image region 21, obtaining a bright image. On the other hand, an upper region and a center region of the image 3c become the dark field image region 22. In the bright field image region 21, a defect (defect of the first kind) such as the dent accompanied by a moderate shape change is visualized in high contrast. On the other hand, in the dark field image regions 22, a defect (defect of the second kind) such as the scratch or the foreign substance having a high scattering property is visualized in high contrast.

Therefore, a bright field image in the upper region of the side surface 10c of the object 10 such as the image 3a in FIG. 3 is obtained by imaging the side surface 10c of the object 10 with only the corresponding light source 103a being turned on. On the other hand, a dark field image in the upper region of the side surface 10c of the object 10 such as the image 3b or 3c in FIG. 3 is obtained by imaging the side surface 10c of the object 10 with only the corresponding light source 103b or 103c being turned on. Likewise, a bright field image in the center region of the side surface 10c of the object 10 such as the image 3b in FIG. 3 is obtained by imaging the side surface 10c of the object 10 with only the corresponding light source 103b being turned on. On the other hand, a dark field image in the center region of the side surface 10c of the object 10 such as the image 3a or 3c in FIG. 3 is obtained by imaging the side surface 10c of the object 10 with only the corresponding light source 103a or 103c being turned on. Further, a bright field image in the lower region of the side surface 10c of the object 10 such as the image 3c in FIG. 3 is obtained by imaging the side surface 10c of the object 10 with only the corresponding light source 103c being turned on. On the other hand, a dark field image in the lower region of the side surface 10c of the object 10 such as the image 3a or 3b in FIG. 3 is obtained by imaging the side surface 10c of the object 10 with only the corresponding light source 103a or 103b being turned on.

By switching the light sources 103 to be turned on as described above, it is possible to obtain both the bright field image and the dark field image in each region of the side surface 10c of the object 10. The images captured by the imaging device 11 are transferred to the processor 12 to undergo the image processing, extracting the defects. The defect such as the dent is extracted mainly from each bright field image region 21. The defect such as the scratch or the foreign substance is extracted mainly from each dark field image region 22.

In general, the intensity of scattered light is high in a specular reflection direction and becomes lower as an angle deviates from that direction. The image is bright in each bright field image region 21 of FIG. 3 because the imaging device 11 receives light specular reflected or scattered at an angle close to the specular reflection direction by the side surface 10c, and a light amount received by the imaging device 11 is large. On the other hand, the image is dark in each dark field image region 22 of FIG. 3 because the imaging device 11 receives light scattered in a direction deviated from the specular reflection direction, and a light amount received by the imaging device 11 is small. If imaging sensitivity of the imaging device 11 is adjusted for a light-receiving amount in each bright field image, scattered light which forms the dark field image in the other region captured at the same time lacks in intensity, making it difficult to extract the defect such as the scratch or the foreign substance in a region of the dark field image. To cope with this, a light-receiving condition of the imaging device 11 in a case in which the upper region of the side surface 10c is illuminated in dark field illumination by the corresponding light source 103c is established such that the imaging device 11 receives a light amount needed to form the dark field image from the upper region illuminated in dark field illumination. That is, the imaging sensitivity of the imaging device 11 is adjusted to that of the dark field image region 22. Note that at least a part of the center region and the lower region is illuminated in bright field illumination.

For example, the intensity of the illumination light emitted from each light source 103c when the dark field image in the upper region of the side surface 10c is captured is higher than that from each light source 103a when the bright field image in the upper region of the side surface 10c is captured. Alternatively, an imaging time of the imaging device 11 when the dark field image in the upper region of the side surface 10c is captured while illuminating it with the illumination light from the corresponding light source 103c is longer than that when the bright field image in the upper region of the side surface 10c is captured while illuminating it with the illumination light from the corresponding light source 103a.

The processor 12 can compose the bright field images in the respective regions and inspect, based on a composed bright field image, the presence/absence of the dent or the like on the side surface 10c. The processor 12 can also compose the dark field images in the respective regions and inspect, based on a composed dark field image, the presence/absence of the scratch, the foreign substance, or the like on the side surface 10c. In this embodiment, it is possible to extract various defects in the respective inspection regions on the side surface 10c of the object 10 by using the bright field image regions 21 and the dark field image region 22. Note that in this embodiment, a defect may be extracted in an intermediate boundary region between each bright field image and each dark field image, in addition to each bright field image region 21 and each dark field image region 22. Thus, according to this embodiment, it is possible to provide an inspection apparatus which certainly detects the defect present on the side surface, having the curvature, of the object.

### Second Embodiment

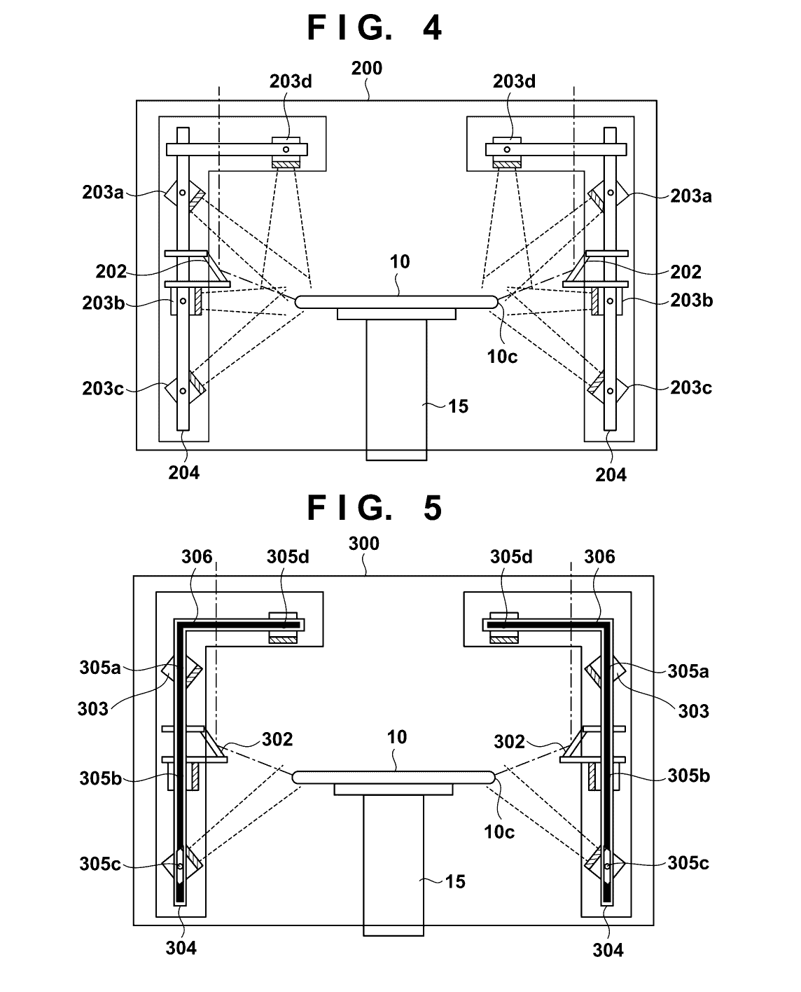

An inspection apparatus of the second embodiment is the same that of the first embodiment except for the arrangement of an illumination device. An illumination device 200 of the second embodiment will be described with reference to FIG. 4. The illumination device 200 includes a plurality of light sources 203, non-transmissive mirrors 202 each serving as a reflection plate, and stands 204 which hold them.

The light sources 203 of the second embodiment include light sources 203a which illuminate side surfaces 10c of an object 10 from diagonally above, light sources 203b which illuminate the side surfaces 10c of the object 10 in the horizontal direction, and light sources 203c which illuminate the side surfaces 10c of the object 10 from diagonally below. The light sources 203a to 203c are equivalent to the light sources 103a to 103c of the first embodiment. In the second embodiment, light sources 203d illuminating the side surfaces 10c of the object 10 from above are further provided, in addition to these three types of light sources 203a to 203c. Some light beams emitted by the light sources 203a to 203d and reflected or scattered by the side surfaces 10c of the object 10 are reflected by the half mirrors 202, and enter an imaging device 11 arranged above the object 10. Each non-transmissive mirror 202 is arranged at a position where light from each of the light sources 203a to 203d is not shielded. Accordingly, an image of an inspection region on each side surface 10c of the object 10 is obtained via the corresponding non-transmissive mirror 202.

By switching the light sources 103 to be turned on as described above, it is possible to obtain both a bright field image and a dark field image in each region of the side surface 10c of the object 10. Images captured by the imaging device 11 are transferred to a processor 12 to undergo image processing, extracting defects. The defect such as a dent is extracted mainly from each bright field image region 21. The defect such as a scratch or a foreign substance is extracted mainly from each dark field image region 22. If imaging sensitivity of the imaging device 11 is adjusted to that of each bright field image region 21, scattered light which forms the dark field image region 22 in the other region imaged at the same time lacks in intensity, making it difficult to extract the defect such as the scratch or the foreign substance from the dark field image region 22. To cope with this, in this embodiment, the imaging sensitivity of the imaging device 11 is adjusted to that of each dark field image. This makes it possible to obtain both the defect such as the dent and the defect such as the scratch or the foreign substance from each bright field image region 21 and each dark field image region 22.

In this embodiment, it is possible to extract various defects in the respective inspection regions on the side surfaces 10c of the object 10 by using the bright field images and the dark field images as described above. In this embodiment, the defects in the inspection regions are extracted by using the bright field images and the dark field images. In addition to these, however, a defect may be extracted in an intermediate region between each bright field image and each dark field image. Thus, according to this embodiment, it is possible to provide an inspection apparatus which certainly detects the defect present on the curved surface of the object. In the second embodiment, not the half mirrors 102 of the first embodiment but the non-transmissive mirrors 202 are used. Thus, the illumination device 200 of the second embodiment is advantageous in that there is no loss in a light amount due to light reflected by and transmitted through each half mirror.

### Third Embodiment

An inspection apparatus of the third embodiment is the same as those of the first and second embodiments except for the arrangement of an illumination device. An illumination device 300 of the third embodiment will be described with reference to FIG. 5. The illumination device 300 includes a light source 303, non-transmissive mirrors 302, and stands 304 which hold them. Each stand (change mechanism) 304 can change the position and light emission direction of the light source 303. A conveyance system 15 conveys an object 10 into an illumination region of the illumination device 300.

Based on an instruction from a processor 12, the light source 303 can be moved along a guide 306 of the stand 304, and a light irradiation direction can be changed by rotation. The light source 303 is moved to a position 305a and rotated such that light is emitted in the vertical direction, thereby illuminating a corresponding side surface 10c of the object 10 from above. The light source 303 is moved to a position 305b and rotated such that light is emitted diagonally below, thereby illuminating the corresponding side surface 10c of the object 10 from diagonally above. The light source 303 is moved to a position 305c and rotated such that light is emitted in the horizontal direction, thereby illuminating the corresponding side surface 10c of the object 10 in the horizontal direction. The light source 303 is moved to a position 305d and rotated such that light is emitted diagonally above, thereby illuminating the corresponding side surface 10c of the object 10 from diagonally below. At the respective positions, a part of light beams emitted by the light source 303 and reflected or scattered by the side surfaces 10c of the object 10 are reflected by the non-transmissive mirrors 302, and enter an imaging device 11 arranged above the object 10. Accordingly, an image of an inspection region on each side surface 10c of the object 10 is obtained.

The processor 12 controls the light source 303 to be turned on when the light source 303 is positioned at the respective positions 305a, 305b, 305c, and 305d. The processor 12 also controls the imaging device 11 to perform imaging in synchronism with movement and turn-on of the light source 303. Consequently, images of the inspection region on each side surface 10c of the object 10 are obtained on a plurality of illumination conditions having different incident angles of illumination light.

By switching the light sources 103 to be turned on as described above, it is possible to obtain both a bright field image and a dark field image in each region of the side surface 10c of the object 10. Images captured by the imaging device 11 are transferred to the processor 12 to undergo image processing, extracting defects. The defect such as a dent is extracted mainly from each bright field image region 21. The defect such as a scratch or a foreign substance is extracted mainly from each dark field image region 22. If imaging sensitivity of the imaging device 11 is adjusted to that of each bright field image, scattered light which forms the dark field image in the other region imaged at the same time lacks in intensity, making it difficult to extract the defect such as the scratch or the foreign substance in the other region from the dark field image. To cope with this, in this embodiment, the imaging sensitivity of the imaging device 11 is adjusted to that of each dark field image regions 22. This makes it possible to obtain both the defect such as the dent and the defect such as the scratch or the foreign substance from each bright field image region 21 and each dark field image region 22.

In this embodiment, it is possible to extract various defects in the respective inspection regions on the side surfaces 10c of the object 10 by using the bright field images and the dark field images as described above. In this embodiment, the defects in the inspection regions are extracted by using the bright field images and the dark field images. In addition to these, however, a defect may be extracted in an intermediate region between each bright field image and each dark field image. Thus, according to this embodiment, it is possible to provide an inspection apparatus which certainly detects the defect present on the curved surface of the object.

The illumination device 300 of this embodiment is more advantageous than the illumination device 100 of the first embodiment in that there is no loss in a light amount due to light reflected by and transmitted through each half mirror. Further, as compared with the first and second embodiments, the illumination device 300 of this embodiment can reduce the number of light sources though it is necessary to move the light sources.

### Embodiment According to Article Manufacturing Method

An inspection apparatus according to each embodiment described above can be used for an article manufacturing method. The article manufacturing method can include a step of performing an inspection on an article (target object) by using the inspection apparatus and a step of processing the object for which the inspection has been performed. The process can include at least one of, for example, processing, cutting, conveyance, assembly (imposition), measurement, and selection. The article manufacturing method according to this embodiment is superior to a conventional method in at least one of the performance, quality, productivity, and production cost of the object.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-161270, filed Aug. 18, 2015, which is hereby incorporated by reference herein in its entirety.

What is claimed is:

1. An inspection apparatus comprising an illumination device, an imaging device, and a processor, and configured to inspect a curved surface of an object including a first region and a second region,
wherein the illumination device is configured to be in a first state in which illumination light is emitted from a first position in a first direction and a second state in which illumination light is emitted from a second position in a second direction,
the imaging device is configured to image the curved surface with the first region undergone bright field illumination by the illumination device in the first state, and image the curved surface with the second region undergone bright field illumination and with the first region undergone dark field illumination by the illumination device in the second state on a light-receiving condition that the imaging device receives a light amount required to obtain a dark field image of the first region undergone the dark field illumination, and
the processor is configured to perform a process for an inspection of the first region based on a bright field image of the first region undergone the bright field illumination and the dark field image of the first region undergone the dark field illumination.

2. The apparatus according to claim 1, wherein the imaging device is configured to image the curved surface with the second region undergone bright field illumination by the illumination device in the second state, and image the curved surface with the first region undergone bright field illumination and with the second region undergone dark field illumination by the illumination device in the first state on a light-receiving condition that the imaging device receives a light amount required to obtain a dark field image of the second region undergone the dark field illumination, and
the processor is configured to perform a process for an inspection of the second region based on a bright field image of the second region undergone the bright field illumination and the dark field image of the second region undergone the dark field illumination.

3. The apparatus according to claim 2, wherein the processor is configured to compose the bright field image of the first region and the bright field image of the second region, and perform a process for a defect in a first kind in the first region and the second region based on the composed bright field image.

4. The apparatus according to claim 2, wherein the processor is configured to compose the dark field image of the first region and the dark field image of the second region, and perform a process for a defect in a second kind in the first region and the second region based on the composed dark field image.

5. The apparatus according to claim 1, wherein an illumination light intensity of the illumination device in the second state on a light-receiving condition for obtaining the dark field image of the first region is higher than that in the first state on a light-receiving condition for obtaining the bright field image of the first region.

6. The apparatus according to claim 1, wherein an imaging time of the imaging device on a light-receiving condition for obtaining the dark field image of the first region is longer than that on a light-receiving condition for obtaining the bright field image of the first region.

7. The apparatus according to claim 1, wherein the illumination device includes a first light source arranged at the first position and configured to emit illumination light in the first direction, and a second light source arranged at the second position and configured to emit illumination light in the second direction.

8. The apparatus according to claim 1, wherein the illumination device includes a light source, and a change mechanism configured to change a position of the light source and an emission direction of illumination light of the light source.

9. The apparatus according to claim 1, further comprising a mirror configured to reflect light, from the curved surface illuminated by the illumination device, toward the imaging device.

10. The apparatus according to claim 9, wherein the mirror is a transmissive mirror and arranged on a path of illumination light from the illumination device.

11. The apparatus according to claim 9, wherein the mirror is a non-transmissive mirror and arranged at a position where illumination light from the illumination device is not shielded by the mirror.

12. An inspection method of inspecting a curved surface of an object including a first region and a second region, the method comprising steps of:
imaging the curved surface with the first region undergone bright field illumination in a first state in which illumination light is emitted from a first position in a first direction;
imaging the curved surface with the second region undergone bright field illumination and with the first region undergone dark field illumination in a second state in which the illumination light is emitted from a second position in a second direction on a light-receiving condition that an imaging device receives a light amount required to obtain a dark field image of the first region undergone the dark field illumination; and
performing a process for an inspection of the first region based on a bright field image of the first region undergone the bright field illumination and the dark field image of the first region undergone the dark field illumination.

13. An inspection apparatus comprising an illumination device, an imaging device, and a processor, and configured to inspect a curved surface of an object including a first region and a second region,
wherein the illumination device is configured to be in a first state in which illumination light is emitted from a first position in a first direction and a second state in which illumination light is emitted from a second position in a second direction,
the imaging device is configured to image the curved surface with the first region undergone bright field illumination and with the second region undergone dark field illumination by the illumination device in the first state, and image the curved surface with the second region undergone bright field illumination and with the first region undergone dark field illumination by the illumination device in the second state, and
the processor is configured to perform a process for an inspection of the first region based on a bright field image of the first region undergone the bright field illumination and a dark field image of the first region undergone the dark field illumination, and perform a process for an inspection of the second region based on a bright field image of the second region undergone the bright field illumination and a dark field image of the second region undergone the dark field illumination.

14. An inspection method of inspecting a curved surface of an object including a first region and a second region; the method comprising steps of:
imaging the curved surface with the first region undergone bright field illumination and with the second region undergone dark field illumination in a first state in which illumination light is emitted from a first position in a first direction;
imaging the curved surface with the second region undergone bright field illumination and with the first region having undergone dark field illumination in a second state in which illumination light is emitted from a second position in a second direction; and
performing a process for an inspection of the first region based on a bright field image of the first region undergone the bright field illumination and a dark field image of the first region undergone the dark field illumination, and performing a process for an inspection of the second region based on a bright field image of the second region undergone the bright field illumination and a dark field image of the second region undergone the dark field illumination.

15. An article manufacturing method, the method comprising steps of:
performing an inspection of an object using an inspection apparatus; and
processing the object, of which the inspection has been performed, to manufacture the article,
wherein the inspection apparatus includes an illumination device, an imaging device, and a processor, and configured to inspect a curved surface of an object including a first region and a second region,
wherein the illumination device is configured to be in a first state in which illumination light is emitted from a first position in a first direction and a second state in which illumination light is emitted from a second position in a second direction,
the imaging device is configured to image the curved surface with the first region undergone bright field illumination by the illumination device in the first state, and image the curved surface with the second region undergone bright field illumination and with the first region undergone dark field illumination by the illumination device in the second state on a light-receiving condition that the imaging device receives a light amount required to obtain a dark field image of the first region undergone the dark field illumination, and
the processor is configured to perform a process for an inspection of the first region based on a bright field image of the first region undergone the bright field illumination and the dark field image of the first region undergone the dark field illumination.

16. An article manufacturing method, the method comprising steps of:
performing an inspection of an object an inspection apparatus; and
processing the object, of which the inspection has been performed, to manufacture the article,
wherein the inspection apparatus includes an illumination device, an imaging device, and a processor, and configured to inspect a curved surface of an object including a first region and a second region,
wherein the illumination device is configured to be in a first state in which illumination light is emitted from a first position in a first direction and a second state in which illumination light is emitted from a second position in a second direction,
the imaging device is configured to image the curved surface with the first region undergone bright field illumination and with the second region undergone dark field illumination by the illumination device in the first state, and image the curved surface with the second region undergone bright field illumination and with the first region undergone dark field illumination by the illumination device in the second state, and
the processor is configured to perform a process for an inspection of the first region based on a bright field image of the first region undergone the bright field illumination and a dark field image of the first region undergone the dark field illumination, and perform a process for an inspection of the second region based on a bright field image of the second region undergone the bright field illumination and a dark field image of the second region undergone the dark field illumination.
